(19) United States
(12) Patent Application Publication
(10) Pub. No.: US 2026/0175781 A1
(43) Pub. Date: Jun. 25, 2026

(54) DOOR LEAF WITH INTEGRATED FOLDING STEP FOR A VEHICLE

(71) Applicant: Bode - Die Tür GmbH, Kassel (DE)

(72) Inventor: Diako Rasekhi Coochesfahani, Kassel (DE)

(21) Appl. No.: 19/421,854

(22) Filed: Dec. 16, 2025

(30) Foreign Application Priority Data
Dec. 23, 2024 (DE) 20 2024 107 554.4
Jul. 22, 2025 (DE) 20 2025 104 231.2

(51) Int. Cl. B60R 3/02

(52) U.S. Cl. CPC B60R 3/02

(57) ABSTRACT

A door system with a door leaf for a vehicle is characterized by an integrated folding step, wherein the folding step has a surface element, which forms a tread surface when the folding step is folded out and an area of the door leaf with the folding step folded in.

### CROSS-REFERENCE TO RELATED APPLICATIONS

This application claims the benefit of German patent application no. 20 2024 107 554.4, filed on 23 Dec. 2024, and claims the benefit of German patent application no. 20 2025 104 231.2, filed on 22 Jul. 2025, the disclosures of which are incorporated herein by reference in their entirety.

### TECHNICAL FIELD

The present disclosure relates to a system and a method for integrating a folding step into a door leaf for vehicles. In particular, the present disclosure relates to a door leaf, which comprises a folding step, which serves as a tread surface when folded out, and as part of the door leaf when folded in.

### BACKGROUND

In the area of vehicle doors, the latter usually serve only as simple barriers between the interior of a vehicle and the outside world. Known systems typically comprise rigid door leaves, which can be either manually or automatically opened and closed. While these door leaves offer basic functions such as protection against weather influences and access control, situations always arise in which additional functions would be desirable. In particular in vehicles that are often used by people with limited mobility, there exists a need for additional aids that facilitate entry and egress.

In known prior art, such aids are often conceived as separate units, which must be secured to the vehicle after the fact. For example, these separate units comprise steps or ramps, which must either be folded out manually or activated by a separate drive system. The disadvantage to these solutions is that they take up additional space and can detract from the vehicle design. In addition, they often require complex installation and maintenance, which increases operating costs and can detract from reliability.

Despite the considerable advances in the area of vehicle access systems, there continues to be a demand for integrated solutions, which are both functional and aesthetically pleasing. One of the challenges lies in developing a solution that can be seamlessly integrated into the existing vehicle design without additional components being visible or detracting from the interior space. In addition, the solution should be robust and reliable, so as to withstand the demands of daily use, while simultaneously being easy to operate, so as to maximize the comfort of the user.

Document DE20 113 258 U1 describes a folding staircase for caravans or motorhomes that are detachably mounted below a door opening of the vehicle. The staircase consists of several horizontal steps, which are hinged together via connecting elements. The staircase can be adjusted between a folded out use position and a folded in transport position. The connecting elements are formed by two pairs of parallel side rails, which form an articulated parallelogram arrangement, and can be fixed in preset positions by a locking device. The folding staircase requires additional space below the door opening, which can detract from the ground clearance of the vehicle.

Document DE10 2008 057 537 A1 relates to a pivoting step, which is hinged to a transportation entry. The entry is formed by a stepped recess in the vehicle floor, and has an immobile step. The pivoting step comprises a foot board and a rear wall section, which is arranged on the longitudinal edge of the foot board. The step can be pivoted from a use position into a nonuse position, so that the bottom side of the step aligns flush with the vehicle floor in the nonuse position. The pivoting step is confined to a stepped recess in the vehicle floor, which limits the possible applications.

DE 10 2013 014 906 A1 shows a folding staircase construction for a motor vehicle, in particular a bus. The construction comprises a folding staircase and an assembly device, with which the folding staircase can be mounted and pivoted on the vehicle. The folding staircase consists of at least two steps, which are connected with each other via a stair offset. The folding staircase can be moved from an inwardly pivoted state, in which it assumes the function of the entry stairs, into an outwardly pivoted state, so as to facilitate entry. The assembly device for the folding staircase is complex and costly.

### SUMMARY

The present disclosure provides an improved access system for vehicles which at least partially overcomes the disadvantages of known systems. In particular, the structure should be relatively simple, while still being resistant.

According to the disclosure, the advantage is achieved by providing a door system with the features of the independent claim.

Accordingly, the door system based on the disclosure has a door leaf for a vehicle with an integrated folding step. The folding step in turn has a surface element, which forms a tread surface when folded out and an area of the door leaf when folded in.

The door leaf thus comprises a conventional, flat door element and an additional surface element, which forms the step when folded out. In the closed state, then, the flat door element and the surface element of the step together comprise the door leaf. In an especially preferred embodiment, the surface element forms a lower area of the door leaf in relation to a subsurface when folded in, for example 10% to 40% of the height of the door element, preferably 15% to 30%.

It is basically possible to provide a folding step to be moved manually, which has no drive for movement purposes. However, a drive system is preferably provided, which drives the folding step, i.e., folds the surface element in and out. The drive system is preferably electrically driven, and to this end has a correspondingly designed and suitable electric motor.

In an especially advantageous embodiment variant, the drive system or its components are arranged inside of the vehicle with the folding step folded in, i.e., with the door closed.

A retaining system for the folding step preferably comprises two jointly connected levers, of which a first lever is pivoted to the vehicle at the end, and jointly connected with the second lever at its other end, wherein the other free end of the second lever facing away from the first lever is pivotably connected with a tread surface.

It can preferably be provided that two retaining systems be provided, which on both sides of the surface element are connected with the latter and the vehicle. The two retaining systems can be driven together by a single electric motor or each separately by their own drive motor.

The levers can advantageously be connected with each other via a shared joint, which controls and synchronizes the movements of the levers or the two parallel arm systems. In an especially preferred embodiment variant, the joint can be designed as a kind of crank mechanism. The folding step can preferably be driven by way of the joint. A motor necessary for this purpose and connected with the joint is preferably arranged inside of the vehicle with the folding step folded in, i.e., with the door closed.

In an especially advantageous embodiment variant, the two retaining systems each have two lever pairs, which are each connected with the surface element and the vehicle. A first attachment trapezoid is arranged on the tread surface per retaining system, and has a first attachment side running inclined to the tread surface, to which the two levers of the retaining system are hinged side by side. In this way, the step is securely held horizontally when folded out.

A second attachment trapezoid per retaining system is arranged on the vehicle side, and has a second attachment side running inclined to the folded out tread surface, to which the two other levers of the retaining system are hinged side by side.

The first and second attachment sides preferably form an angle of 60° to 120°, preferably 90°, with the tread surface folded in.

The position of the folded out surface element or the folded out tread surface can be easily changed in the X, Y and Z directions via suitable adjusting elements. For example, the adjusting elements can comprise the retaining systems themselves. However, other adjusting elements are also conceivable, for example slotted holes or latching, interlocking turntables.

A height difference of the folded out surface element in relation to a vehicle floor inside of the vehicle or to the platform can preferably be changed via differing angles of the levers of the retaining systems to each other and/or to the vehicle. An inclination of the tread surface or the folded out surface element relative to a horizontal plane can preferably also be changed.

It is especially advantageous that the surface element can act as a locking element when folded in, retaining and locking the door leaf in a door opening. To this end, for example, the surface element, when folded in, can abut against an exterior side of the upper, other flat door element and block it in the opening direction.

### BRIEF DESCRIPTION OF THE DRAWINGS

The following figures show the basic functional principle and structure of a door system according to the disclosure in a highly simplified schematic diagram. The shown elements are not to scale, and components not important for the disclosure are not shown. The disclosure is not to be limited to the shown initial example; rather, the disclosure also comprises other embodiment variants of the basic idea, and changes to these exemplary embodiments are possible without departing from the protective scope of the present disclosure. The figures show:

FIG. 1: a sectional view of the door with closed and locked door leaf from the side,

FIG. 2: a sectional view of the door system on FIG. 1. from the side with partially folded out folding step, and

FIG. 3: a sectional view of the door system on FIG. 1 from the side with folding step folded out.

### DETAILED DESCRIPTION OF THE DRAWINGS

The figures each show a schematic and highly simplified view of a door system 20 according to the disclosure for a vehicle 22, for example a rail vehicle. A vehicle wheel 21 is denoted, which rolls onto a rail 23. The door system 20 has a door leaf 24, which closes a door opening. The door leaf 24 has an integrated folding step 26, which has a surface element 28, which has a tread surface 30 when folded out, and an area of the door wing 24 with the folding step 26 folded in.

The door leaf 24 is thus essentially comprised of two elements, namely the surface element 28 and an additional surface element 32, which corresponds to the remaining door leaf. In the exemplary embodiment shown, the surface element 28 of the folding step 26 forms a lower area of the door leaf 24 that faces a subsurface or platform 38.

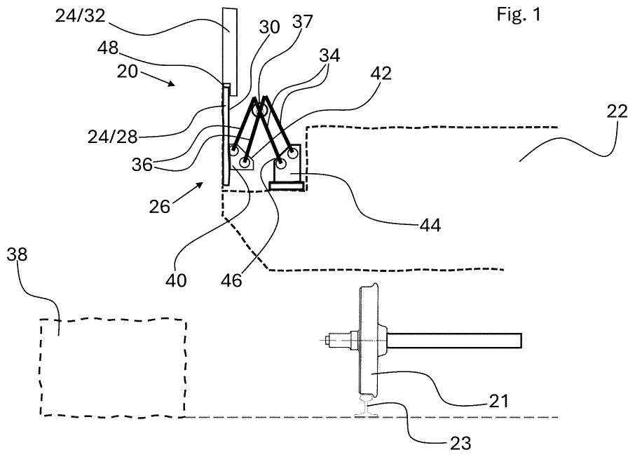

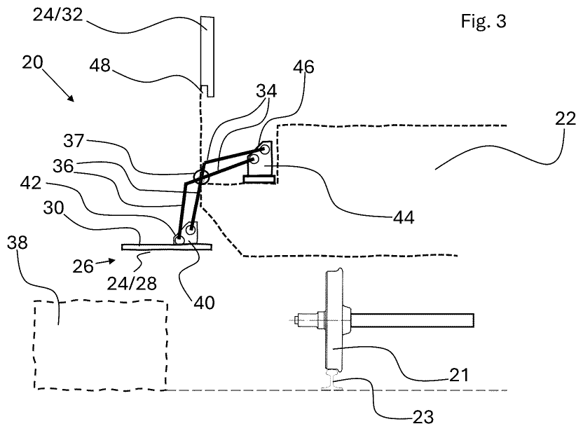

The side of the surface element 28 that faces a vehicle interior in the closed state forms the tread surface 30, while its outwardly facing side in the closed state forms an area of an exterior side of the door leaf 24 (see FIGS. 1 and 3).

In the shown exemplary embodiment, the surface element 28 is connected with the vehicle 22 in a horizontal plane on either side by means of two respective jointly connected levers 34, 36, which form a retaining system. A first lever 34 is connected with the vehicle 22 at one end, and with the second lever 36 at its other end, and the second lever 36 is connected with the surface element 28 with its other free end facing away from the first lever 34. An electric motor (not shown) is used to drive the folding step 26; the levers 34, 36 and the motor then together comprise a drive system. Sensors (not shown) can further be provided, and monitor a distance to the platform 38.

In an especially preferred embodiment variant, the distance between the surface element 28 serving as the tread surface 30 and the platform 38 can be adjusted by varying the deflection of the levers 34, 36. The surface element 28 or tread surface 30 can also be adjusted in relation to an inclination to the subsurface, wherein the inclination is also changed via the levers 34, 36. While the levers 34, 36 thus serve as adjusting elements for aligning the folding step 26, other suitable and potential additional elements are also conceivable.

Respectively provided on the surface element 28 or the tread surface 30 for the second lever 36 is a first attachment trapezoid 40, which has a first attachment side 42 running inclined to the tread surface, to which the two levers 36 of the drive system are hinged side by side in a direction transverse to the vehicle 22.

A second attachment trapezoid 44 is arranged on the vehicle 22, and has a second attachment side 46 running inclined to the folded out tread surface 30, to which the two first levers 34 are hinged side by side.

The levers 34, 36 are advantageously connected with each other via a shared joint 35. The joint 37 controls and synchronizes the movements of the levers 34, 36 or the two parallel arm systems. In an especially preferred embodiment variant, the joint 37 can be designed as a kind of crank mechanism. The folding step 26 can preferably be driven via the joint 37.

With the folding step 26 folded in, the first and second attachment sides 42, 46 form an angle of 60° to 120°, preferably of 70° to 100°.

The figures also illustrate that, with the folding step 26 folded in, the side edge of the surface element 28 facing the additional surface element 32 outwardly abuts against the latter, and thus blocks it in the opening direction. The folding step 26 thus additionally serves to lock the door leaf 24 or the additional surface element 32. In the exemplary embodiment shown, a recess 48 is provided for this purpose in the lower area of the additional surface element 32 facing the surface element 28, in which the corresponding side edge of the surface element 28 comes to abut.

This yields a completely flat, flush exterior side of the door leaf 24, and the surface element 28 does not protrude relative to the additional surface element 32.

The drive system and the kinematic components of the folding step 26 are advantageously placed inside of the vehicle 22, and thus better protected against environmental influences and external stresses.

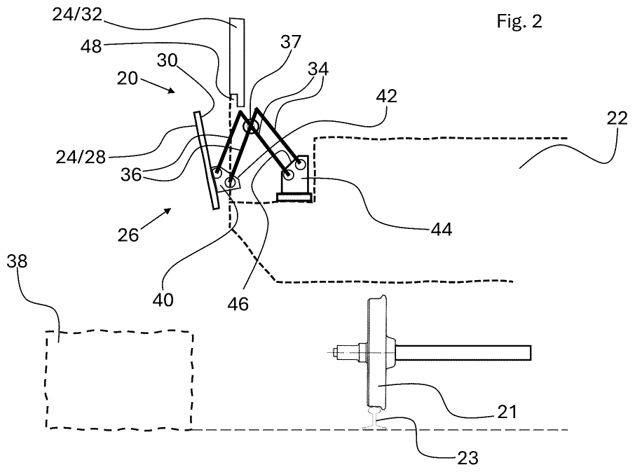

FIGS. 1-3 show how the folding step 26 folds out or in. In the first phase, the door leaf 24 is closed and locked. The folding step 26 is integrated into the door leaf 24, and is in the folded in position. In this position, the folding step 26 forms the lower area of the door leaf 24, and requires no additional installation space.

In the second phase, the upper area of the door leaf 24 remains closed as the additional surface element 32, while the folding step 26 folds out. The surface element 28 moves toward the outside.

In the third phase, the folding step 26 is completely folded out. The door leaf 24, which is still closed on FIG. 3, can be opened. The position of the folded out stairs can be adjusted in the X, Y and Z directions, so as to ensure an optimal adjustment to the platform or entry area of the vehicle. The folding step 26 is then stable, and ready for use.

The figures illustrate the kinematics and functionality of the folding step 26 in the different phases of operation. The depicted lever mechanisms and drive systems are conceived in such a way as to offer a reliable and robust solution for accessing vehicles without requiring additional installation space while simultaneously protecting against external influences.

The design of the disclosure ensures a stable and secure tread surface 30 when the folding step 26 is folded out, and a reliable closure function when it is folded in.

1. A door system with a door leaf for a vehicle, characterized by an integrated folding step, wherein the folding step has a surface element, which forms a tread surface when folded out and an area of the door leaf with the folding step folded in.

2. The door system according to claim 1, wherein the surface element, when folded in, forms a lower area of the door leaf facing in the direction of a vehicle floor.

3. The door system according to claim 1, wherein a retaining system is provided for folding the surface element in and out.

4. The door system according to claim 3, wherein the retaining system is arranged inside of the vehicle with the folding step folded in.

5. The door system according to claim 4, wherein the retaining system has two jointly connected levers, of which a first lever is connected to the vehicle at the first end, and connected with the second lever at the second end, and the other free end of the second lever facing away from the first lever is connected with the surface element.

6. The door system according to claim 3, wherein two retaining systems are provided, which on both sides of the surface element are connected with the latter and the vehicle.

7. The door system according to claim 6, wherein the two retaining systems each have two lever pairs, which are each connected with the surface element and the vehicle.

8. The door system according to claim 7, wherein a first attachment trapezoid is arranged on the surface element (28) per retaining system, and has a first attachment side running inclined to the tread surface, to which the two levers of the retaining system are hinged side by side.

9. The door system according to claim 8, wherein a second attachment trapezoid per retaining system is arranged on the vehicle side, and has a second attachment side running inclined to the folded out tread surface, to which the two other levers of the retaining system are hinged side by side.

10. The door system according to claim 9, wherein the first and second attachment sides form an angle of 60° to 120° with the folding step folded in.

11. The door system according to claim 1, wherein the position of the folded out surface element can be changed in the X, Y and Z directions via adjusting elements.

12. The door system according to claim 11, wherein the adjusting elements are formed by the retaining systems.

13. The door system according to claim 11, wherein a height difference of the folded out surface element in relation to a vehicle floor inside of the vehicle is configured to be changed via differing angles of the levers of the retaining systems to each other and/or to the vehicle.

14. The door system according to claim 1, wherein the surface element, when folded in, acts as a locking element, and locks the door leaf in a door opening.

15. The door system according to claim 14, wherein the surface element, when folded in, abuts against on an exterior side against an additional flat door element, and thereby blocks the additional flat door element in an opening direction.
